(19) United States
(12) Patent Application Publication
(10) Pub. No.: US 2023/0174746 A1
(43) Pub. Date: Jun. 8, 2023

(54) ADDITIVE COMPOSITION AND USE THEREOF, CONDENSATION POLYMER COMPOSITION, MOLDING COMPOUND AND MOLDING COMPOUNDS PRODUCED THEREFROM, AND MOLDED PARTS AND USE THEREOF

(71) Applicant: FRAUNHOFER-GESELLSCHAFT ZUR FÖRDERUNG DER ANGEWANDTEN FORSCHUNG E.V., München (DE)

(72) Inventors: Matthias POLIDAR, Darmstadt (DE); Elke METZSCH-ZILLIGEN, Darmstadt (DE); Rudolf PFAENDNER, Darmstadt (DE)

(73) Assignee: FRAUNHOFER-GESELLSCHAFT ZUR FÖRDERUNG DER ANGEWANDTEN FORSCHUNG E.V., München (DE)

(21) Appl. No.: 17/996,747

(22) PCT Filed: Mar. 24, 2021
(86) PCT No.: PCT/EP2021/057632

§ 371 Date: Oct. 20, 2022

(30) Foreign Application Priority Data
Apr. 22, 2020 (DE) 10 2020 205 100.3

(51) Int. Cl. C08K 5/5333; C08K 5/5313; C08K 5/41

(52) U.S. Cl. CPC C08K 5/5333; C08K 5/5313; C08K 5/41

(57) ABSTRACT

The invention relates to an additive composition with inorganic sulfites, organic derivatives of sulfurous acid and/or thiosulfates, and organic phosphorus compounds, said composition being capable of accelerating the hydrolytic decomposition of a thermoplastic condensation polymer upon working said additive composition into the condensation polymer. The invention additionally relates to a condensation polymer composition which is additivized with an additive composition according to the invention. The invention additionally relates to a method for the hydrolytic decomposition of a thermoplastic condensation polymer and to uses of the additive composition according to the invention and the thermoplastic condensation polymer composition.

The present invention relates to an additive composition that comprises inorganic sulfites, organic derivatives of the sulfurous acid, and/or thiosulfates, and organic phosphorous compounds and that is able to accelerate the hydrolytic decomposition of a thermoplastic condensation polymer on use when being worked into said thermoplastic condensation polymer. The present invention additionally relates to a condensation polymer composition that is addivitated with an additive composition in accordance with the invention. The invention additionally relates to a method for the hydrolytic decomposition of a thermoplastic condensation polymer, to uses of the additive composition in accordance with the invention and of the thermoplastic condensation polymer composition.

Condensation polymers such as PET and polyamides such as PA-6 are important plastics for packaging and for technical applications that are frequently also provided for long-term use purposes. Polymers on a polyester base from renewable resources such as PLA (polylactide) or PBS (polybutylene succinate) are today above all furthermore considered as a possible replacement material for oil-based plastics in the packaging industry and for agricultural applications. These applications in the form of films, for example, however, rather have a brief service life. Independently of the service life, it is, however, necessary that condensation polymers do not experience any (pre-existing) damage during the manufacture of parts or on compounding during the processing in order not to prematurely suffer any loss of property such as in the mechanical properties. Additives such as stabilizers and/or antioxidants are frequently admixed for this purpose.

A series of possibilities have been described for an accelerated decomposition of polycondensation polymers, in particular of polylactic acid. The decomposition can, for example, be accelerated by special environmental conditions, e.g. by the use of selected microorganisms (W. Pattanasuttichonlakul et al., International Biodeterioration and Biodegradation, 2018, 132, 74-83) or of enzymes (WO 2005/063037).

Other possibilities are the addition of decomposition promoting additives to obtain a photocatalytic decomposition such as TiO₂ nanoparticles (Y. Luo et al. J. Appl. Pol. Sci. 2018, 46509, 1-8) or silica nanoparticles (P. Georgiopoulus et al. Journal of Biomaterials Applications 2014, 29, 662-674) or oxidation promoting additives such as manganese stearate (CN 103408827).

Methods are furthermore known that influence the decomposition of PLA by the addition of inorganic substances Such as MgO or ZnO (US 20140360728) or organic fillers such as chitosan or keratin (M. A. Elsawy et al. Renewable and Sustainable Energy Reviews 2017, 79, 1346-1352).

PLA blends have furthermore been described in combination with faster decomposable polymers such as PLA blends with polybutylene succinate (Y. Want et al., Polym Bull. 2016, 73, 1067-1083).

The previously known methods for accelerated decomposition either only have to be used after the manufacture of plastic parts (microorganisms, enzymes) or generally change the decomposition characteristics (photochemical, oxidative) or the properties of the material (fillers, blends). It is furthermore known that the decomposition in particular takes place at low or high pH values (acid or base catalyzed ester splitting, A. Göpferich, Biomaterials, 1996, 17, 103-114)j; however, an acid or base environment in processing is counterproductive since great damage to the polymer thereby already takes place.

Inorganic sulfites are e.g. proposed in the form of calcium sulfite or lead sulfite as stabilizers for polymers containing halogen such as PVC (e.g. EP 0 313 113, U.S. Pat. No. 3,542,725, US 2003/0104954) and for polyvinylpyrrolidone (U.S. Pat. No. 2,872,433, DE 10 2005 005 974), but have previously not been described for the hydrolytic decomposition of thermoplastic polycondensation polymers such as polyesters or polyamides in the processing or manufacture of molded parts.

Organic esters of the sulfurous acid are generally known for the stabilization of polymers (e.g. DD 24 79 13, U.S. Pat. No. 3,542,725).

The use of sulfurous catalysts of oxidization state +6 for preparing polylactic acid (PLA) via solid phase condensation (JP 2011-201946) and the addition of different stabilizer classes that may also include sulfur compounds in different oxidation states have likewise been described. The aim is inter alia to obtain a polymer having hydrolysis stability.

It was therefore the object of the present invention to develop an additive composition that, on the one hand, makes possible a processing of the polycondensation polymers without or with only minor (pre-existing) damage, i.e. that acts in a stabilizing manner in the thermoplastic processing of the polymer, and that, on the other hand, accelerates or controls hydrolytic decomposition in the environment.

This object is achieved by the features of claim 1 with respect to an additive composition for the acceleration of the hydrolytic decomposition of thermoplastic condensation polymers, by the features of claim 11 with respect to a condensation polymer composition, by the features of claim 20 with respect to a molding compound or a molded part, by the features of claim 21 with respect to a method for the hydrolytic decomposition of condensation polymers, by the features of claim 22 with respect to a use of an additive composition, and by the features of claim 23 with respect to uses of the condensation polymer compositions.

The respective dependent claims in this respect represent advantageous further developments.

The invention thus relates in a first aspect to an additive composition comprising or consisting of
a) at least one inorganic substance, at least one organic derivative of the sulfurous acid, and/or at least one thiosulfate, and
b) at least one organic phosphorus compound.

It has surprisingly been found that the additive composition in accordance with the invention permits the preparation of condensation polymer compositions having accelerated hydrolytic decomposition in the environment without premature property loss in processing.

For example, the additive composition in accordance with the invention can be incorporated in the condensation polymer composition during the thermal processing of the condensation polymers, in particular by admixing, additivation, or incorporation with or into the thermoplastic condensation polymers.

An exemplary thermal processing of the condensation polymers can, for example, represent the processing in the thermoplastic state, with the condensation polymer as a rule being melted, preferably by mixers, kneaders, or extruders. Extruders such as single screw extruders, twin screw extruders, planetary gear extruders, ring extruders, and co-kneaders that are preferably equipped with a vacuum degassing are preferred as processing machines. The processing can take place here under air or, optionally, under inert gas conditions. In this respect, the addition or incorporation of the additive composition can take place during the processing.

It is equally possible to mix the additive composition before the thermal processing with the thermoplastic condensation polymers that can be present, for example, as chips, powder, beads, or pellets and to subsequently process the mixture in the thermoplastic state.

The thermal processing preferably takes place under aprotic conditions. Aprotic conditions are understood such that compounds that can easily release a proton, e.g. acids or also water, are absent. Aprotic conditions are in particular characterized in that the thermoplastic condensation polymer has a water content of up to 0.5 wt %, preferably of up to 0.05 wt %. The water content here can be determined by known methods, e.g. in accordance with ISO 15512:2019.

The inorganic sulfites can be sulfites, disulfites, or hydrogen sulfites. Preferred salts of the sulfurous acid (sulfites) are salts of monovalent, bivalent, trivalent, or tetravalent metals, alkali metals, alkaline earth metals, and aluminum or zinc such as sodium sulfite, potassium sulfite, lithium sulfite, calcium sulfite, magnesium sulfite, aluminum sulfite or zine sulfite are preferred.

Exemplary disulfites are potassium disulfite or sodium disulfite.

An exemplary thiosulfate is e.g. sodium thiosulfate.

The forms of the salts listed free of crystal water are very particularly preferred. Salts are to be designated free of crystal water here that lose at most 10 wt. % crystal water under the respective processing conditions. This also in particular includes salts that can be transitioned into this state by conventional drying methods.

The sulfites, disulfites, or thiosulfates used are furthermore to be selected such that a sufficient thermal stability is present at the processing temperatures of the respective polymers. Corresponding degradation temperatures are familiar to the skilled person or can be determined, for example, by thermogravimetric analysis (TGA).

The organic derivative of the sulfurous acid, an organic ester of the sulfurous acid or of the sulfinic acid is preferably a linear or branched aliphatic or aromatic ester.

The organic phosphorous compound is preferably hydrolyzable and thus comprises at least one ester group, preferably two, particularly preferably 3, ester groups. The hydrolytic stability of esters of the phosphorous acid depends on the structure of the respective alcohol. Aromatic polyesters, i.e. phenol derivatives and sterically hindered structures have higher hydrolytic resistance than aliphatic structures, i.e. alcohol derivatives. The organic phosphorous compound preferably has at least 1, particularly preferably at least 2, very particularly preferably 3 aliphatic ester groups per P atom. In particular linear ester groupings, i.e. having smaller steric hindrance, are furthermore preferred.

A further preferred embodiment provides that the organic phosphorous compound is selected from the group consisting of

phosphites having one, two, or 3 linear or branched alkoxy groups

phosphites selected from the group consisting of

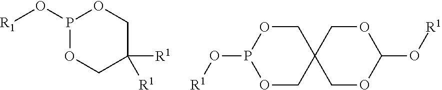

where R¹ is the same or different on every occurrence and is selected from the group consisting of linear or branched alkyl residues having 1 to 36 carbon atoms and aryl residues,

compounds of the formula P(OR¹)₃, where R¹ is selected from the group consisting of linear or branched alkyl residues having 4 to 32 carbon atoms, in particular trilauryl phosphite, triisodecyl phosphite, tridecyl phosphite, trihexadecyl phosphite, trioctadecyl phosphite, tribehenyl phosphite, triarachidyl phosphite, triceryl phosphite, trioleyl phosphite, and trioleyl phosphite, tris(2-ethylhexyl) phosphite,

diphosphites, and higher molecular homologs

partially esterified phosphonic acid compounds such as monostearyl phosphite (or its tautomeric form monostearyl phosphonate) or distearyl phosphite (distearyl phosphonate) and their alkali, alkaline earth salts, aluminum, or zinc salts.

Examples for a diphosphite are tetraethyl diphosphite or tetrapropyl diphosphite. An example for a triphosphite is the P,P′-bis(2-hydroxyethyl) ester of the triphosphoric acid. Oligophosphites and polyphosphites (oligomer and polymer phosphites) are described, for example, In WO 2011102861, WO 201420519, or WO 2020123986. The compounds named there are equally covered by the present invention.

Phosphates, diphosphaes, meta phosphates, and polyphosphates that are derived from the previously named phosphites are further covered.

The phosphorous atom in the previously named phosphates, diphosphates, metaphosphates, and polyphosphates, that are derived from the previously named phosphites, is present in the oxidation state +V− instead of +III as in the phosphites.

It is very particularly preferred that the organic phosphorous compound is a phosphite and is selected from the group consisting of the following compounds:

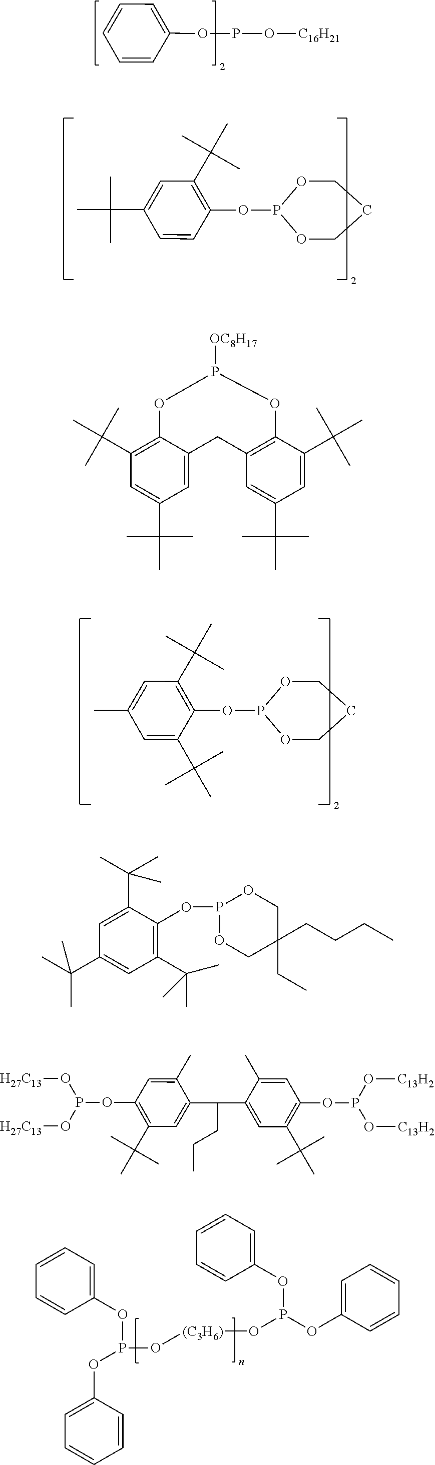

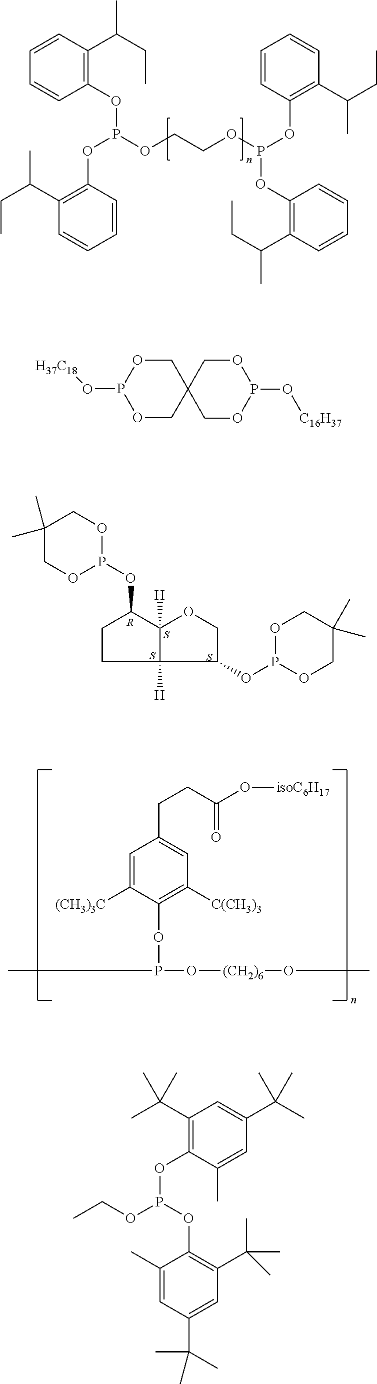

where n is from 3 to 100.

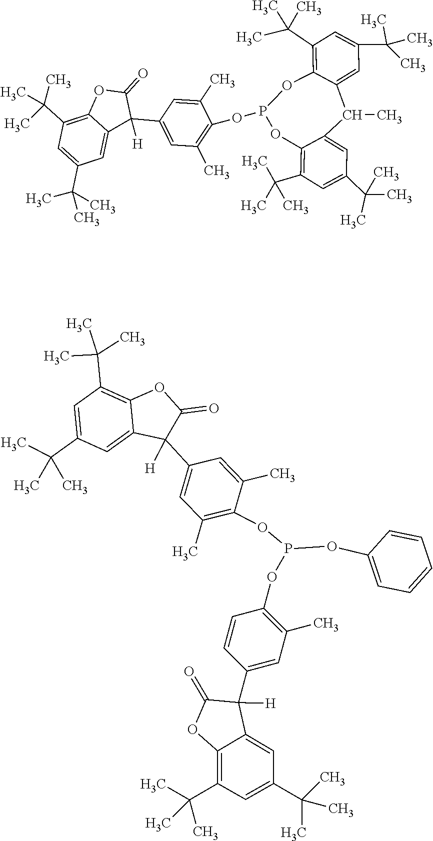

A preferred phosphonite that can be used for the purposes of the present invention is the following compound:

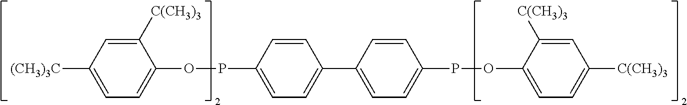

Advantageous phosphates are selected from the group consisting of trialkyl phosphates such as trilauryl phosphate, triisodecyl phosphate, tridecyl phosphate, trihexadecyl phosphate, trioctadecyl phosphate, tribehenyl phosphate, triarachidyl phosphate, triceryl phosphate, tricetyl phosphate, trioleyl phosphate or tris(2-ethylhexyl) phosphate, diphosphates, polyphosphates, and partially esterified phosphorous acid compounds such as monostearyl phosphate or distearyl phosphate, and mixtures of at least two phosphates consisting of the group of monoalkyl phosphates, dialkyl phosphates, and trialkyl phosphates.

In accordance with a further preferred embodiment, in the additive composition, the totality of the at least one sulfite, of the at least one organic derivative of the sulfurous acid, and/or of the at least one thiosulfate and the totality of the at least one organic phosphorus compound is present at a weight ratio of 20:1 to 1:20, preferably 10:1 to 1:10, particularly preferably 5:1 to 1:5.

In accordance with a further aspect, the present invention relates to a condensation polymer composition comprising or consisting of
(A) at least one condensation polymer, and
(B) an additive composition in accordance with one of the preceding claims.

Provision is made in accordance with a further preferred embodiment that the condensation polymer is selected from the group consisting of polyesters of aliphatic or aromatic dicarboxylic acids and diols, or of hydroxylic carboxylic acids such as polylactic acid (PLA), polybutylene succinate (PBS), polybutylene succinate-co-adipate (PBSA)), poly(butylene adipate) (PBA), polyethylene terephthalate (PET), polybutylene terephthalate (PBT), polypropylene terephthalate (PPT), (poly(ethylene-2,5-furandicarboxylate)) (PEF), polyethylene naphthylate, poly-1,4-dimethylolcyclohexane terephthalate, polyhydroxy benzoate, polyhydroxy naphthalate, polycaprolactone (PCL), poly-3-hydroxybutyrate (PHB), poly-4-hydroxybutyrate, poly-3-hydroxyvalerate (PHV), poly(hexamethylene succinate), and copolymers and mixtures or blends of two or more of the above-named polymers,

polyamides such as PA 6, PA 6.6, PA 6.10, PA 4.6, PA 4.10, PA 6.12, PA 10.10, PA 10.12, PA 12.12, PA 11, PA 12;

semiaromatic polyamides such as polypththalamides, e.g. prepared from terepththalic acid and/or isophthalic acid and aliphatic diamines or of aliphatic dicarboxylic acids such as adipic acid or sebacic acid and aromatic diamines such as 1,4- or 1,3-diamine benene;

polycarbonates or polyester carbonates;

and mixtures, combinations, or blends of two or more of the above-named polymers.

The condensation polymer is in particular selected from the group preferably consisting of aliphatic polyesters such as PLA, PBA, and copolymers thereof. PLA and the PLA copolymers are preferably synthesized by ring-opening polymerization of D-lactide and/or L lactide, optionally with comonomers selected from hydrocarboxylic acid, in particular glycolic acid, 4-hydroxy butyric acid, 3-hydroxy butyric acid, 3-hydroxy valeric acid, or mandelic acid.

Further aliphatic polyesters are from aliphatic diols such as ethylene glycol, 1,3-propanediol, 1,2-propanediol, 1,4-butanediol, 1.5-pentanediol, neopentyl glycol, 1.6-hexanediol, and aliphatic dicarboxylic acids such as malonic acid, succinic acid, glutaric acid, adipic acid, pimelic acid, suberic acid, azelaic acid, sebacic acid, brassylic acid, fumaric acid, or itaconic acid.

In addition to aliphatic structures, aromatic structures can also be present to a secondary degree of up to 20 mol %, preferably less than 10 mol %, very particularly preferably less than 1 mol %. Suitable aromatic structures in diols are hydroquinone, resorcinol, 2,6-naphthalenediol, 1,8-naphthalenediol, bisphenol-A; in dicarboxylic acids terepththalic acid, isophthalic acid, naphthalene-2,-6-dicarboxylic acid; 2,5-furan dicarboxylic acid is an example of a heterocyclic aromatic dicarboxylic acid.

The additive composition of 0.01 to 10.00 wt %, preferably 0.05 to 5.00 wt %, particularly preferably of 0.10 to 2.00 wt % is preferably contained in the condensation polymer composition in accordance with the invention with respect to the total condensation polymer composition.

The condensation polymer composition in accordance with the invention can additionally comprise at least one additive selected from the group consisting of primary antioxidants, secondary antioxidants, UV absorbers, light stabilizers, metal deactivators, filler deactivators, antiozonants, nucleation agents, anti-nucleation agents, toughening agents, mold lubricants, rheological modifiers, thixotropic agents, chain extenders, processing aids, mold removal aids, flame retardant agents, pigments dyes, optical brighteners, antimicrobial active agents, antistatic agents, slip agents, anti-blocking agents, coupling agents, crosslinking agents, anti-cross-linking agents, hydrophilization agents, hydrophobing agents, hydrolysis stabilizers, bonding agents, dispersing agents, compatibilizers, oxygen scavengers, acid scavengers, expanding agents, degradation additives, defoaming agents, odor scavengers, marking agents, and anti-fogging agents.

It is of advantage here if the at least one additive of 0.01 to 5.00 wt %, preferably 0.05 to 3.00 wt %, particularly preferably of 0.10 to 1.00 wt % is contained with respect to the total condensation polymer composition.

Plasticizers, fibers such as fiberglass and/or carbon fibers, and fillers are not considered as additives. In the event that plasticizers, fibers, and/or filler are contained in the condensation polymer composition, these substances can be contained in their totality up to 80 parts by weight with respect to 100 parts by weight of the above-described condensation polymer composition.

In a preferred embodiment, the compositions in particular comprise further classes of nucleation agents, additives to reduce molecular weight (chain extenders) or fillers.

Preferred nucleation agents are, talcum, alkali or alkaline earth salts of mono- and polyfunctional carboxylic acids such as benzoic acid, succinic acid, adipic acid, e.g. sodium benzoate, zinc glycerolate, aluminumhydroxy-bis(4-tert-butyl)benzoate, 2,2′-methylene-bis-(4,6-di-tert-butylphenyl)phosphate, and trisamides and diamides such as trimesic acid tricyclohexylamide, trimesic acid tri(4-methylcyclohexylamide), trimesic acid tri(tert·butylamide), N,N′, N″-1,3,5 benzene triyltris(2,2-dimethyl-propanamide) or 2,6-naphthalene dicarboxylic acid cyclohexylamide or orotic acid.

Preferred additives to increase the molecular weight (chain extenders) are diepoxides, bis-oxazonlines, bis-oxazolones, bis-oxazines, diisoscyanates, dianhydrides, bis-acyllactams, bis-maleimides, dicyanates, carbodiimides. Further suitable chain extenders are polymer compounds such as polystyrene polyacrylate polyglycidyl(meth)acrylate copolymers, polystyrene maleic acid anhydride copolymers, and polyethylene maleic acid anhydride copolymers.

Preferred fillers and/or reinforcement materials are calcium carbonate, silicates, talcum, mica, kaolin, metal oxides and metal hydroxides, black carbon, graphite, wood flour, or fibers of natural products such as cellulose, fiberglass, carbon fibers, polyaramide fibers, and other synthetic polymer fibers. Further suitable fillers are hydrotalcites or zeolites or phyllosilicates such as montmorillonite, bentonite, beidellite, mica, hectorite, saponite, vermiculite, ledikite, magadite, illite, kaolinite, wollastonite, attapulgite.

Examples for further additives that can additionally comprise the compositions in accordance with the invention are primary and secondary antioxidants:

Suitable primary antioxidants (A) are phenolic antioxidants, amines, and lactones.

Suitable phenolic antioxidants are, for example:

Alkylated monophenols, such as 2,6-di-Cert-butyl-4-methylphenol, 2-Cert-butyl-4,6-dimethylphenol, 2,6-di-Cert-butyl-4-ethylphenol, 2,6-di-tert-butyl-4-n-butylphenol, 2,6-di-Cert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear or branched nonylphenols such as 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof;

alkylthiomethyl phenols, such as 2,4-dioctylthiomethyl-6-Cert-butylphenol, 2,4-dioctylthiomethyl-6-methylphenol, 2,4-dioctylthiomethyl-6-ethylphenol, 2,6-didodecylthiomethyl-4-nonylphenol;

hydroquinones and alkylated hydroquinones, such as e.g. 2,6-di-Cert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-Cert-butyl-4-hydroxyanisole, 3,5-di-Cert-butyl-4-hydroxyanisole, 3,5-di-Cert-butyl-4-hydroxyphenyl stearate, bis(3,5-di-tert-butyl-4-hydroxylphenyl)adipate;

tocopherols, such as α-, β-, γ-, δ-tocopherol and mixtures hereof (vitamin E);

hydroxylated thiodiphenyl ethers, such as 2,2′-thiobis(6-Cert-butyl-4-methylphenol), 2,2′-thiobis(4-octylphenol), 4,4′-thiobis(6-Cert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide;

alkylidene bisphenols, such as 2,2′methylenebis(6-cert-butyl-4-methylphenol), 2,2′-methylenebis(6-cert-butyl-4-ethylphenol), 2,2′-methylenebis[4-methyl-6-(α-methylcyclohexyl)phenol], 2,2′-methylenebis(4-methyl-6-cyclhexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-cert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol, 4,4′-methylenebis(6-tert-butyl-2-methylphenol), 1,1-bis(5-tert-butyl-4-hydroxy-2-methylphenyl)butane, 2,6-bis(3-cert-butyl-5-methyl-2-hydroxybenzyl)-4-methylphenol, 1,1,3-tris(5-cert-butyl-4-hydroxy-2-methylphenyl)butane, 1,1-bis(5-tert-butyl-4-hydroxy-2-methylphenyl)-3-n-dodecylmercaptobutane, ethylene glycol-bis[3,3-bis(3′-tert-butyl-4′-hydroxyphenyl)butyrate], bis(3-Cert-butyl-4-hydroxy-5-methylphenyl)dicyclopentadiene, bis[2-(3′-Cert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-cert-butyl-4-hydroxy-2-methylphenyl)pentane;

O-, N- and S-benzyl compounds, such as 3,5,3′,5′-tetra-tert-butyl-4,4′-dihydroxydibenzylether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-cert-butyl-4-hydroxybenzyl)sulfide, isooctyl-3,5-di-tert-butyl-4-hydroxybenzylmercaptoacetate;

hydroxybenzylated malonates, such as dioctadecyl-2,2-bis(3,5-di-tert-butyl-2-hydroxybenzyl)malonate, dioctadecyl-2-(3-cert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate;

aromatic hydroxybenzyl compounds, such as 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-cert-butyl-4-hydroxybenzyl)phenol;

triazine compounds, such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl)isocyanurate;

benzyl phosphonates, such as dimethyl-2,5-di-cert-butyl-4-hydroxybenzylphosphonate, diethyl-3,5-di-cert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethylester of 3,5-di-tert-butyl-4-hydroxybenzylphosphonic acid;

acylaminophenols, such as 4-hydroxylauranilide, 4-hydroxystearanilide, octyl-N-(3,5-di-tert-butyl-4-hydroxyphenyl)carbamate;

esters of β-(3,5-di-cert-butyl-4-hydroxyphenyl)propionic acid with monohydric or polyhydric alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;

esters of β-(5-cert-butyl-4-hydroxy-3-methylphenyl)propionic acid with monohydric or polyhydric alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane, 3,9-bis[2-{3-(3-tert-butyl-4-hydroxy-5-methylphenyl)propionyloxy}-1,1-dimethylethyl]-2,4,8,10-tetraoxaspiro[5.5]undecane;

esters of β-(3,5-dicyclohexyl-4-hydroxyphenyl)propionic acid with monohydric or polyhydric alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;

esters of (3,5-di-cert-butyl-4-hydroxyphenyl)acetic acid with monohydric or polyhydric alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;

amides of β-(3,5-di-cert-butyl-4-hydroxyphenyl)propionic acid, such as N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, marketed by Uniroyal);

ascorbic acid (vitamin C).

Particularly preferred phenolic antioxidants are the following structures:

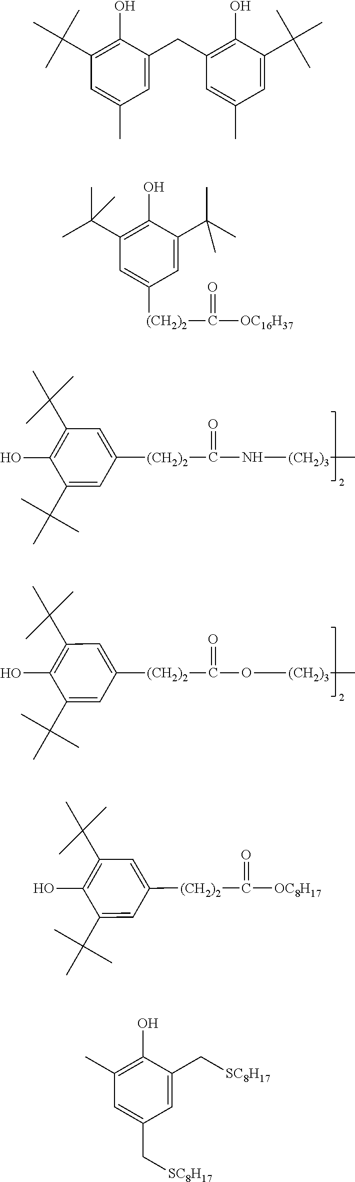

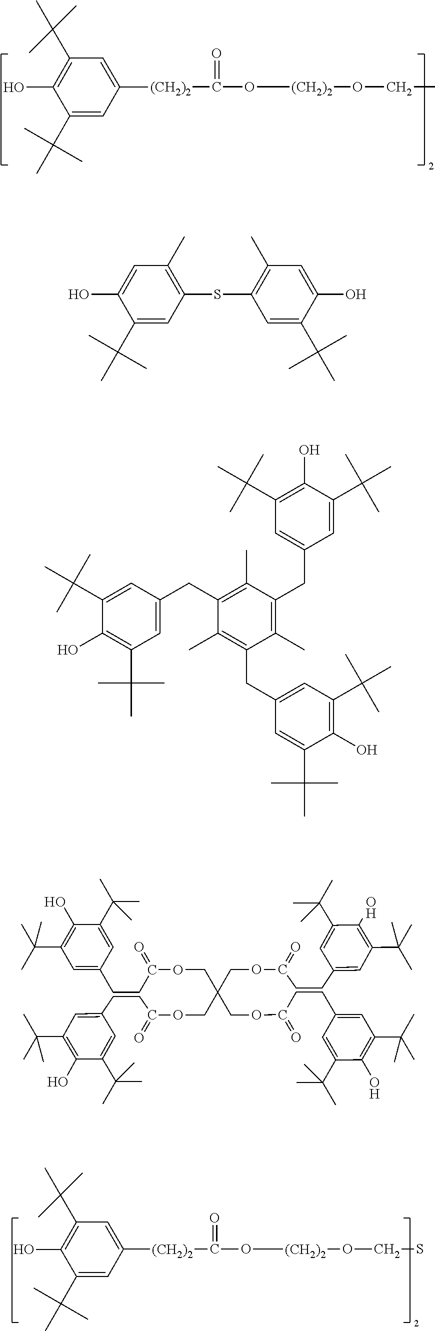

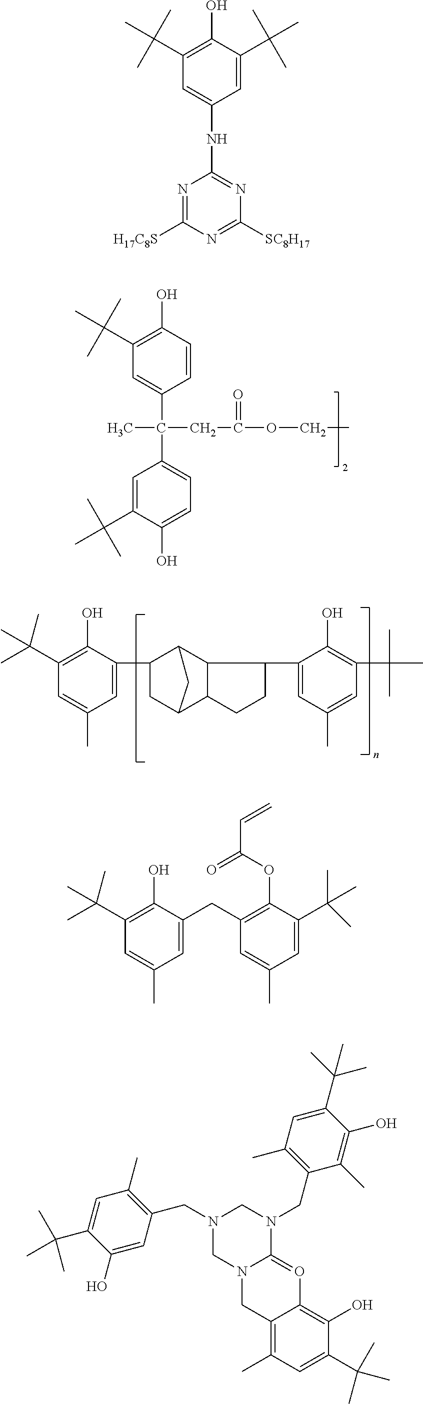

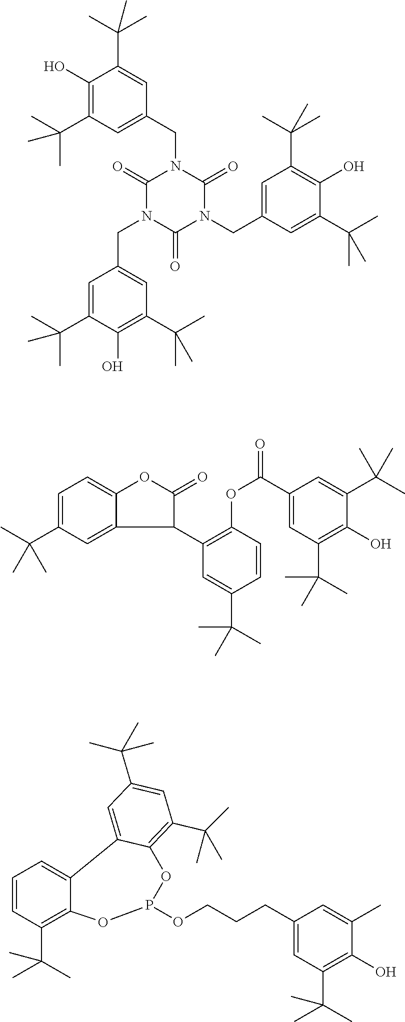

Further particularly preferred phenolic antioxidants are based on sustainable raw materials such as tocopherols (vitamin E), tocotrienols, tocomonoenols, carotenoids, hydroxytyrosol, flavonols such as chrysin, quercetin, hesperidin, neohesperidin, naringin, morin, camphor oil, fisetin, anthocyanins such as delphinidin and malvidin, curcumin, carnosic acid, carnosol, rosemarinic acid, tannin, and resveratrol.

Suitable aminic antioxidants are, for example:

N,N′-di-isopropyl-p-phenylene diamine, N,N′-di-sec-butyl-p-phenylene diamine, N,N′-bis(1,4-dimethylpentyl)-p-phenylene diamine, N,N′-bis(1-ethyl-3-methylpentyl)-p-phenylene diamine, N,N′-bis(1-methylheptyl)-p-phenylene diamine, N,N′-dicyclohexyl-p-phenylene diamine, N,N′-diphenyl-p-phenylene diamine, N,N′-bis(2-naphthyl)-p-phenylene diamine, N-isopropyl-N′-phenyl-p-phenylene diamine, N-(1,3-dimethylbutyl)-N′-phenyl-p-phenylene diamine, N-(1-methylheptyl)-N′-phenyl-p-phenylene diamine, N-cyclohexyl-N′-phenyl-p-phenylene diamine, 4-(p-toluene sulfamoyl)diphenylamine, N,N′-dimethyl-N,N′-di-sec-butyl-p-phenylene diamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylamino-phenol, bis(4-methoxyphenyl)amine, 2,6-di-tert-butyl-4-dimethylaminomethyl-phenol, 2,4′-diaminodiphenylmethane, 4,4′-diaminodiphenylmethane, N,N,N′,N′-tetra-methyl-4,4′-diaminodiphenylmethane, 1,2-bis[(2-methyl-phenyl)amino]ethane, 1,2-bis(phenylamino)propane, (o-tolyl)biguanide, bis[4-(1′,3′-dimethylbutyl)phenyl]amine, Cert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated Cert-butyldiphenylamines, 2,3-dihydro-3,3-dimethyl-4H-1,4-benzothiazine, phenothiazine, a mixture of mono- and dialkylated Cert-butyl/tert-octylphenothiazines, a mixture of mono- and dialkylated Cert-octylphenothiazinene, N-allylphenothiazine, N,N,N′,N′-tetraphenyl-1,4-diaminobut-2-ene and mixtures or combinations hereof.

Preferred aminic antioxidants are: N,N′-di-isopropyl-p-phenylene diamine, N,N′-di-sec-butyl-p-phenylene diamine, N,N′-bis(1,4-dimethylpentyl)-p-phenylene diamine, N,N′-bis(1-ethyl-3-methylpentyl)-p-phenylene diamine, N,N′-bis(1-methylheptyl)-p-phenylene diamine, N,N′-dicyclohexyl-p-phenylene diamine, N,N′-diphenyl-p-phenylene diamine, N,N′-bis(2-naphthyl)-p-phenylene diamine, N-isopropyl-N′-phenyl-p-phenylene diamine, N-(1,3-dimethylbutyl)-N′-phenyl-p-phenylene-diamine, N-(1-methylheptyl)-N′-phenyl-p-phenylene diamine, N-cyclohexyl-N′-phenyl-p-phenylene diamine.

Further preferred aminic antioxidants are hydroxylamines or N-oxides (nitrones) such as N,N-dialkylhydroxylamines, N,N-dibenzylhydroxylamine, N,N-dilaurylhydroxylamine, N,N-distearylhydroxylamine, N-benzyl-α-phenylnitrone, N-octadecyl-α-hexadecylnitrone, and Genox EP (Addivant) in accordance with the formula:

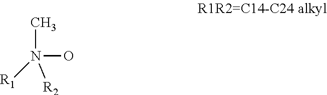

Suitable lactones are benzofuranones and indolinones such as 3-(4-(2-acetoxyethoxy)phenyl]-5,7-di-tert-butyl-benzofuran-2-one, 5,7-di-tert-butyl-3-(4-(2-stearoyloxyethoxy)phenyl]benzofuran-2-one, 3,3′-bis[5,7-di-tert-butyl-3-(4-(2-hydroxyethoxy]phenyl)benzofuran-2-one), 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2,3-dimethylphenyl)-5,7-di-tert-butyl-benzofuran one.

Suitable secondary antioxidants are organosulfur compounds such as sulfides and disulfides, e.g. distearylthiodipropionate, dilaurylthiodipropionate; ditridecyldithiopropionate, ditetradecylthiodipropionate, 3-(dodecylthio)-, 1,1′-[2,2-bis[[3-(dodecylthio)-1-oxopropoxy]methyl]-1,3-propandiyl] propanoic acid ester.

Suitable light stabilizers are, for example, compounds based on 2-(2′-hydroxyphenyl) benzotriazoles, 2-hydroxy benzophenones, esters of benzoic acids, acrylates, oxamides, and 2-(2-hydroxyphenyl)-1,3,-5-triazines.

Suitable 2-(2′-hydroxyphenyl)benzotriazoles are, for example, 2-(2′-hydroxy-5′methylphenyl)benzotriazole, 2-(3′,5′-di-Cert-butyl-2′-hydroxyphenyl)benzotriazole, 2-(5′-tert-butyl-2′-hydroxy-phenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl-5-chlorobenzotriazole, 2-(3′-sec-butyl-5′-tert-butyl-2′-hydroxy-phenyl)benzotriazole, 2-(2′-hydroxy-4′-octyloxyphenyl)benzotriazole, 2-(3′,5′-di-Cert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-Cert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the product of the transesterification of 2-[3′-tert-butyl-5′-(2-methoxycarbonylethyl)-2′-hydroxyphenyl]-2H-benzotriazole with polyethyleneglycol 300; [R—CH₂CH₂—COO—CH₂CH₂—]—₂, where R=3′-tert-butyl-4′-hydroxy-5′-2H-benzotriazole-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole.

Suitable 2-hydroxybenzophenones are, for example, 4-hydroxy-, 4-methoxy-, 4-octyloxy-, 4-decyloxy-4-dodecyloxy, 4-benzyloxy, 4,2′,4′-trihydroxy- and 2′-hydroxy-4,4′-dimethyoxy derivatives of the 2-hydroxy benzophenones.

Suitable acrylates are, for example, ethyl-α-cyano-β,β-diphenylacrylate, isooctyl-α-cyano-β,β-diphenylacrylate, methyl-α-carbomethoxycinnamate, methyl-α-cyano-β-methyl-p-methoxycinnamate, butyl-α-cyano-β-methyl-p-methoxycinnamate, methyl-α-carbomethoxy-p-methoxycinnamate and N-(β-carbomethoxy-β-cyanovinyl)-2-methylindoline.

Suitable esters of benzoic acids are, for example, 4-tert-butylphenylsalicylate, phenylsalicylate, octylphenylsalicylate, dibenzoylresorcinol, bis(4-tert-butylbenzoyl)resorcinol, benzoylresorcinol, 2,4-di-tert-butylphenyl-3,5-di-tert-butyl-4-hydroxybenzoate, hexadecyl-3,5-di-cert-butyl-4-hydroxybenzoate, octadecyl-3,5-di-tert-butyl-4-hydroxybenzoate, 2-methyl-4,6-di-tert-butylphenyl-3,5-di-tert-butyl-4-hydroxybenzoate.

Suitable oxamides are, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixtures with 2-ethoxy-2′-ethyl-5,4′-di-Cert-butoxanilide, mixtures of o- and p-methoxy-disubstituted oxanilides and mixtures of o- and p-ethoxy-disubstituted oxanilides.

Suitable 2-(2-hydroxyphenyl)-1,3,5-triazines are, for example, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy octyloxyphenyl)-4,6-bis(4-methylphenyl-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)-phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy) hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl-1,3,5-triazine.

Suitable metal deactivators are, for example, N,N′-diphenyloxamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyldihydrazide, oxanilide, isophthaloyldihydrazide, sebacoyl-bis-phenylhydrazide, N,N′-diacetyladipoyldihydrazide, N,N′-bis(salicyloyl)oxylyldihydrazide, N,Ne-bis(salicyloyl)thiopropionyldihydrazide.

Suitable hindered amines are, for example 1,1-bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)-n-butyl-3,5-di-tert-butyl-4-hydroxybenzylmalonate, the condensation product from 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyl)hexamethylene diamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane tetracarboxylate, 1,1′-(1,2-ethandiyl)-bis(3,3,5,5-tetramethylpiperazinone), 4-benzoyl-2,2,6,6-tetramethylpiperidine, 4-stearyloxy-2,2,6,6-tetramethylpiperidine, linear or cyclic condensation products of N,N′-bis(2,2,6,6-tetramethyl-4-piperidyl)hexamethylene diamine and 4-morpholino-2,6-dichloro-1,3,5-triazine, the reaction product of 7,7,9,9-tetramethyl-2-cycloundecyl-1-oxa-3,8-diaza oxospiro-[4,5]decane and epichlorhydrine.

Oligomeric and polymeric hindered amines of the following structures are preferred:

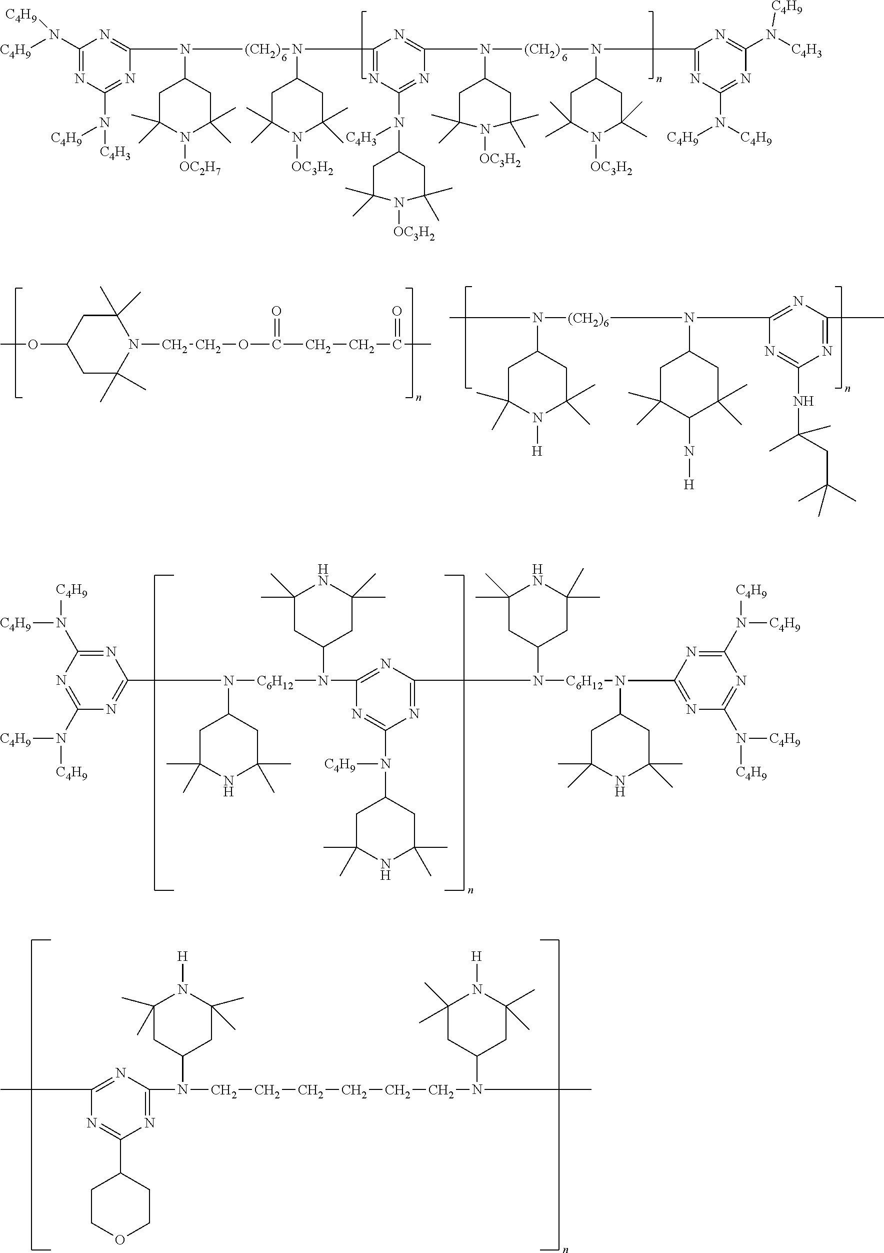

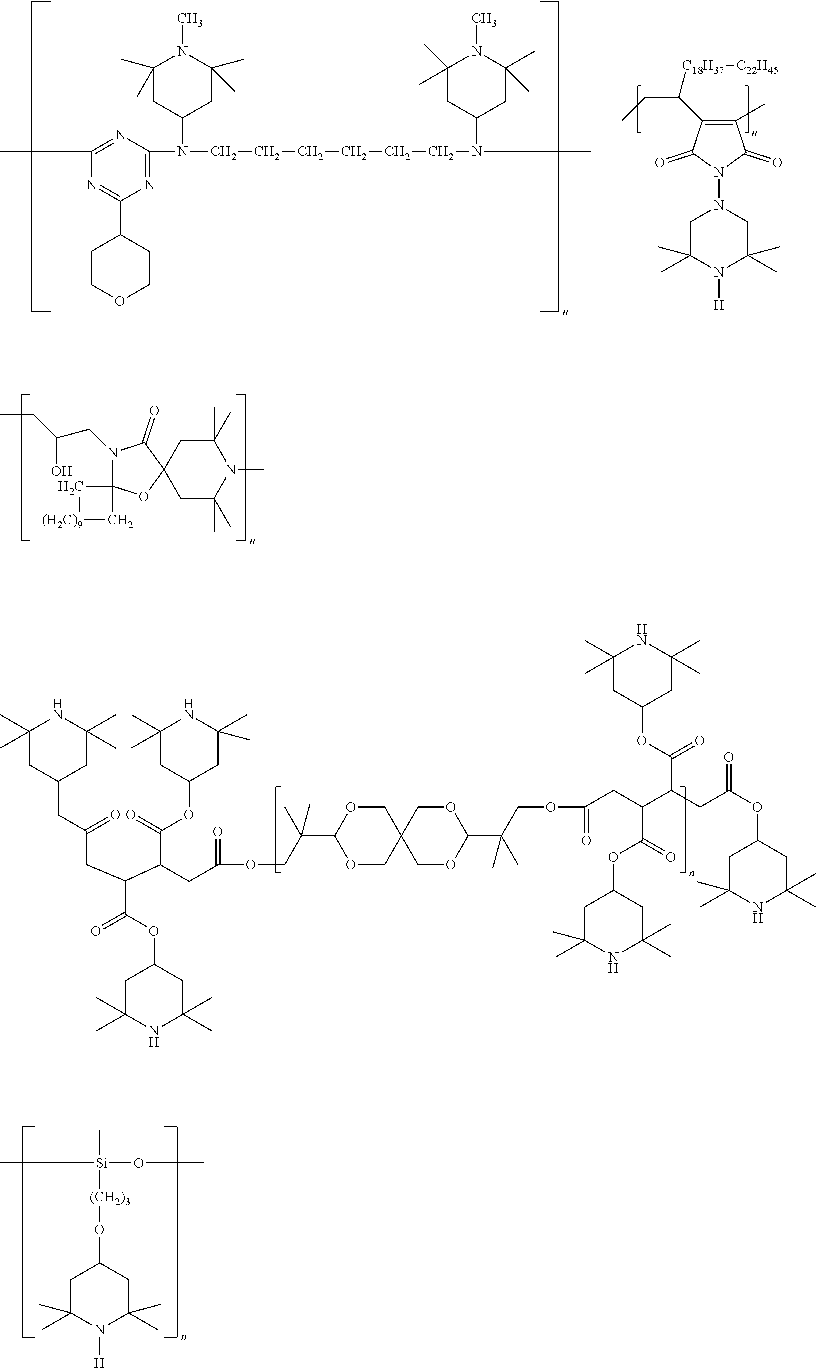

In the above-named compounds, n respectively means 3 to 100.

Suitable dispersion agents are, for example:

polyacrylates, for example, copolymers having long chain side groups, polyacrylate block copolymers, alkylamides: for example, N,N′-1,2-ethanediylbisoctadecanamide sorbitan esters, for example, monostearyl sorbitan esters, titanates and zirconates, reactive copolymers having functional groups, for example, polypropylene-co-acrylic acid, polypropylene-co-maleic anhydride, polyethylene-co-glycidyl methacrylate, polystyrene-alt-maleic anhydride-polysiloxanes: for example, dimethylsilanediol-ethylene oxide copolymer, polyphenylsiloxane copolymer, amphiphilic copolymers: for example, polyethylene block polyethylene oxide, dendrimers, for example, dendrimers comprising hydroxyl groups.

Suitable antinucleation agents are azine dyes such as nigrosin.

Suitable flame retardant agents are in particular inorganic flame retardant agents such as Al(OH)₃, Mg(OH)₂, AlO(OH), MgCO₃, phyllosilicates such as montmorillonite or sepiolite, unmodified or organically modified double salts such as Mg-Al-silicates, POSS (polyhedral oligomeric silsesquioxane) compounds, huntite hydromagnesite or halloysite

Suitable pigments can be of an inorganic or organic nature. Inorganic pigments are, for example, titanium dioxide, zinc oxide, zinc sulfide, iron oxide, ultramarine, black carbon; organic pigments are, for example, anthraquinones, anthanthrones, benzimidazolones, chinacridones, diketoptyrrolopyrrols, dioxazines, inanthrones, isoindolines, azo compounds, perylenes, phthalocyanines or pyranthrones. Further suitable pigments include effect pigments on a metal basis or pearl gloss pigments on a metal oxide basis.

Suitable optical brighteners are, for example, bis-beznzoxazoles, phenylcumarines, or bis(styryl)biphenyls and in particular optical brighteners of the formulas:

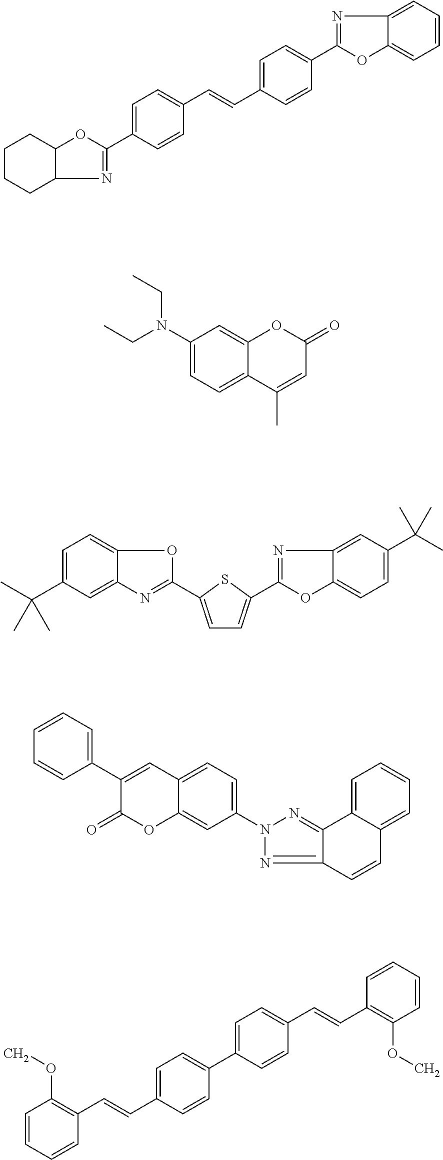 [SMILES: C(=C\c1ccc(-c2nc3ccccc3o2)cc1)/c1ccc(C2=NC3CCCCC3O2)cc1 ; CCN(CC)c1ccc2c(C)cc(=O)oc2c1 ; CC(C)(C)c1ccc2oc(-c3ccc(-c4nc5cc(C(C)(C)C)ccc5o4)s3)nc2c1 ; O=c1oc2cc(-n3nc4ccc5ccccc5c4n3)ccc2cc1-c1ccccc1 ; COc1ccccc1/C=C/c1ccc(-c2ccc(/C=C/c3ccccc3OC)cc2)cc1]

Suitable filler deactivators are, for example, polysiloxanes, polyacrylates, in particular block copolymers such as polymethacrylic acid polyalkyene oxide or polyglycidyl(meth)acrylates and their copolymers, e.g. with sytrene and epoxides of e.g. the following structures:

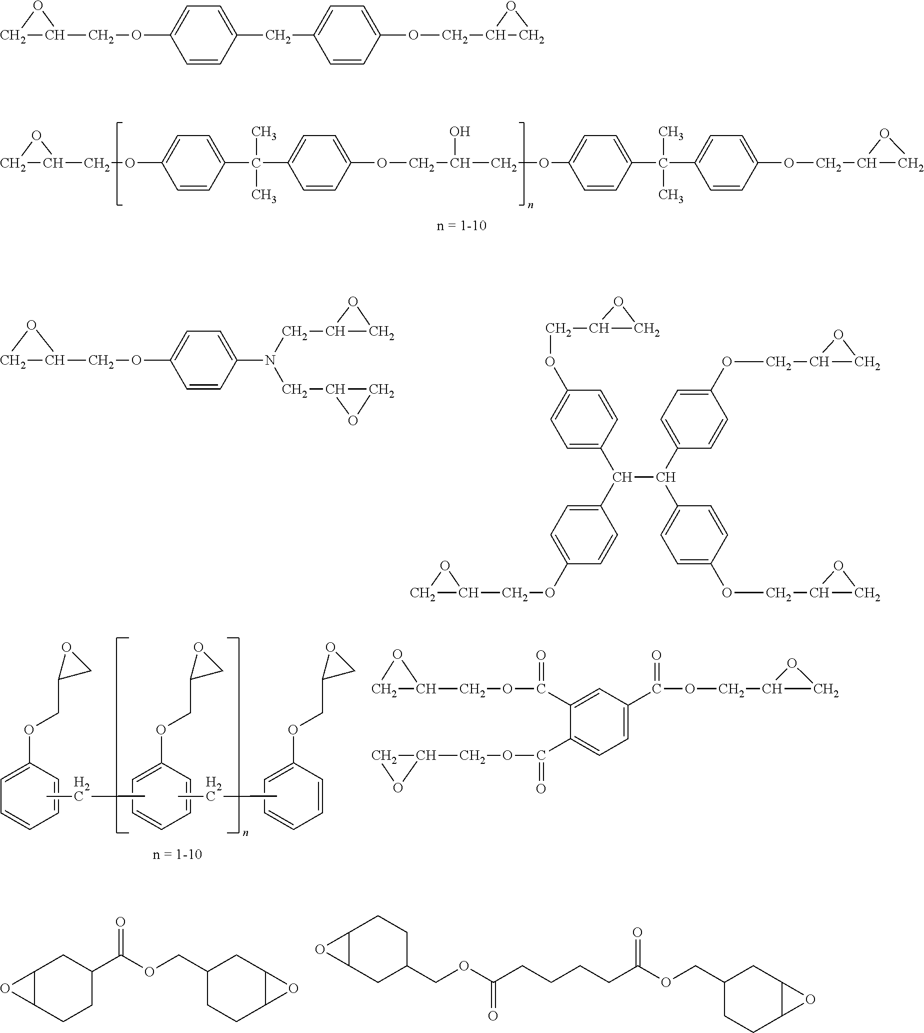

Suitable antistatic agents are, for example, ethoxylated alkylamines, fatty acid esters, alkylsulfonates, and polymers such as polyetheramides.

Suitable antiozonants are the above-named amines such as N,N′-di-isopropyl-p-phenylene diamine, N,N′-di-sec-butyl-p-phenylene diamine, N,N′-bis(1,4-dimethylpentyl)-p-phenylene diamine, N,N′-dicyclohexyl-p-phenylene diamine, N-isopropyl-N′-phenyl-p-phenylene diamine, N-(1,3-dimethylbutyl)-N′-phenyl-p-phenylene diamine, N-(1-methylheptyl)-N′-phenyl-p-phenylene diamine, N-cyclohexyl-N′-phenyl-p-phenylene diamine.

Suitable demolding aids are, for example, montan wax.

The incorporation of the additives in accordance with the invention and optionally of the additional additives into the plastic takes place by typical processing methods, with the polymers being melted and being mixed with the additive composition in accordance with the invention and the optionally further additives, preferably by mixers, kneaders, and extruders. Extruders such as single screw extruders, twin screw extruders, planetary gear extruders, ring extruders, and co-kneaders that are preferably equipped with a vacuum degassing are preferred as processing machines. The processing can take place here under air or, optionally, under inert gas conditions.

The additive compositions in accordance with the invention can furthermore be prepared and incorporated in a polymer in the form of so-called master batches or concentrates that, for example, include 10-90% of the stabilizers or compositions in accordance with the invention.

The present invention furthermore relates to a molding compound or to a molded part that can be or is manufactured from the condensation polymer composition in accordance with the invention, in particular in the form of foils (films), in particular agricultural films such as mulch films, tunnel films, or perforated films, ribbons, hollow bodies and foams, injection molded parts, fibers, sections and other extrudates, parts from additive or generative production processes such as fused layer modeling (FLM), layer laminate modeling (LLM), selective laser sintering (SLS), and other 3D printing processes, packaging for foodstuffs or cosmetic products, encapsulations of active ingredients and biologically active substances, dressing materials, surgical suture material, and/or hygiene products, in particular as elements of disposable diapers, sanitary towels, and tampons.

In a further embodiment, the present invention relates to a method for the hydrolytic decomposition of condensation polymers in which an above-described additive composition in accordance with the invention is additivated to the condensation polymer and the additivated composition is exposed to a hydrolyzing condition. The conditions of the hydrolysis are given when the plastic composition comes into contact with water, e.g. due to humidity, in particular high humidity >30%, in particular also in sewage works, in the composting of waste products, and generally in the environment, e.g. in rivers and oceans.

The present invention additionally relates to the use of an above-described additive composition in accordance with the invention for the acceleration of the hydrolysis of a condensation polymer additivated with the additive composition on the exposure of the additivated condensation polymer to hydrolyzing conditions compared with a condensation polymer not additivated with the additive composition.

It is particularly advantageous here that the described use of the additive composition in accordance with the invention simultaneously permits a processing stabilization under aprotic conditions of the thermoplastic polymers in which they are incorporated and simultaneously allows an acceleration of the hydrolytic decomposition of the condensation polymers under protic conditions in the application.

The present invention furthermore relates to the use of the condensation polymer composition in accordance with one of the claims
for the manufacture of packaging, in particular packaging for foodstuffs or cosmetic products;
in the pharmaceutical industry, in particular for the encapsulation of active ingredients and other biologically active substances;
in medical technology, in particular for the manufacture of dressing material and surgical suture material;
in hygiene products, in particular as a component of disposable diapers, sanitary towels, and tampons; and/or
in agricultural applications, e.g. for the manufacture of agricultural films such as mulch films, tunnel films, or perforated films.

The present invention will be described in more detail with reference to the following embodiments without restricting the invention to the specifically shown parameters.

### EMBODIMENTS

Luminy L 175 (≤0.5% D-lactic acid in accordance with the certificate, MVR=4.7 cm³/10 min, measured at 190° C./2.16 kg stamped weight) of the company of Corbion was used as PLA. The polymers were dried at 80° C. in a vacuum drying cabinet for at least 16 h before processing.

The manufacture of the examples in accordance with the invention and of the comparison examples took place by extrusion using a parallel twin screw extruder Process 11 of the company Thermo Scientific, having a screw diameter of 11 mm and a length to diameter ratio (/D) of 40.

The additives were manually mixed with the matrix polymer in a plastic bag and were volumetrically metered. The phosphate that is fluid at room temperature was diluted in ethyl acetate, was mixed with the polymer already derived at 80° C. in the vacuum furnace for 16 h, and was subsequently dried at 60° C. in the vacuum furnace for at least 16 h. The processing took place at a throughput of 1 kg/h and a screw speed of 200 r.p.m. at 200° C.

The polymer was stored as pellets in deionized water at 58° C. and the MVR was determined after different times.

The measurement of the MVR took place on a melt index test unit Ml-2 of the company Göttfert at a test temperature of 190° C. and a stamped weight of 2.16 kg. The samples were dried for approximately 16 h in the vacuum furnace at 80° C. before the measurement. The preheating time amounted to 4 minutes. The MVR is indicated in cm³/10 min.

| | | | | | MVR after |
|---|---|---|---|---|---|
| | | | MVR after | MVR after | 168 h |
| | | MVR after | 48 h water | 96 h water | water |
| Example | Additive | extrusion | storage | storage | storage |
| Comparison | Without | 5.4 | 13.7 | 26 | 66 |
| example 1 | additive | | | | |
| Example 1 in | 0.4% sodium | 5.2 | 21 | 48 | 152 |
| accordance with | sulfite + 0.1% | | | | |
| the invention | phosphite | | | | |
| Example 2 in | 0.25% sodium | 6.3 | 32 | 81 | 306 |
| accordance with | sulfite + 0.25% | | | | |
| the invention | phosphite | | | | |
| Example 3 in | 0.1% sodium | 6.2 | 46 | 132 | >>300 |
| accordance with | sulfite + 0.4% | | | | |
| the invention | phosphite | | | | |
| Example 4 in | 0.5% sodium | 7.2 | 42 | 124 | 280 |
| accordance with | sulfite + 0.5% | | | | |
| the invention | phosphite | | | | |
| Example 5 in | 0.25% sodium | 8.0 | 60 | 202 | >300 |
| accordance with | sulfite + 0.5% | | | | |
| the invention | phosphite | | | | |
| Example 6 in | 0.1% sodium | 9.4 | 59 | 155 | >300 |
| accordance with | sulfite + 0.5% | | | | |
| the invention | phosphite | | | | |
| Example 7 in | 0.25% sodium | 4.4 | 11.6 | 28 | 79 |
| accordance with | sulfite + 0.25% | | | | |
| the invention | phosphate | | | | |
| Example 8 in | 0.1% sodium | 4.8 | 16.2 | 45 | 138 |
| accordance with | sulfite + 0.4% | | | | |
| the invention | phosphate | | | | |

Weston 618F (manufacturer: SI Group) of the following structure was used as the phosphite:

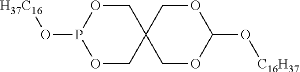

Trioctylphosphate (Alfa Aesar) of the following structure was used as the phosphate:

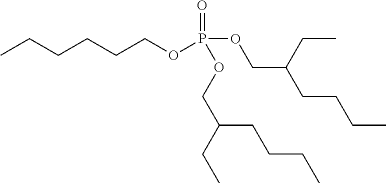 [SMILES: CCCCCCOP(=O)(OCC(CC)CCCC)OCC(CC)CCCC]

The combination of sulfite and phosphite or of sulfite and phosphate (examples in accordance with the invention) demonstrate a very much faster hydrolysis over the comparison example since a higher MVR is obtained in the same time of the water storage. The hydrolysis resistance of the polycondensation polymer can be controlled by a tailored additive recipe with a set ratio of sulfite to phosphite or phosphate.

1-23. (canceled)

24. An additive composition comprising:
(a) at least one inorganic substance, at least one organic derivative of sulfurous acid or sulfinic acid, and/or at least one thiosulfate, and
(b) at least one organic phosphorus compound.

25. The additive composition in accordance with claim 24, wherein the inorganic substance is a sulfite, a disulfite, or a hydrogen sulfite of a monovalent, bivalent, trivalent, or tetravalent metal.

26. The additive composition in accordance with claim 24, wherein the organic derivative of sulfurous acid or sulfinic acid is an organic ester of sulfurous acid or the sulfinic acid.

27. The additive composition in accordance with claim 24, wherein the inorganic thiosulfate is a thiosulfate of a monovalent, bivalent, trivalent, or tetravalent metal.

28. The additive composition in accordance with claim 24, wherein the organic phosphorous compound is hydrolyzable.

29. The additive composition in accordance with claim 24, wherein the organic phosphorus compound is selected from the group consisting of
phosphites having one, two, or 3 linear or branched alkoxy groups,
phosphites of the formulas: 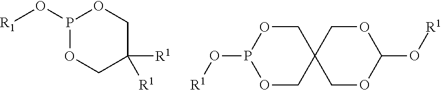
wherein R¹ is the same or different on every occurrence and is selected from the group consisting of linear or branched alkyl residues having 1 to 36 carbon atoms and aryl residues,
compounds of the formula P(OR¹)₃, where R¹ is selected from the group consisting of linear or branched alkyl residues having 4 to 32 carbon atoms, and
phosphates, diphosphates, metaphosphates, and polyphosphates that are derived from said phosphites.

30. The additive composition of claim 29, wherein the compound of formula the formula P(OR¹)₃ is selected from the group consisting of trilauryl phosphite, triisodecyl phosphite, tridecyl phosphite, trihexadecyl phosphite, trioctadecyl phosphite, tribehenyl phosphite, triarachidyl phosphite, triceryl phosphite, trioleyl phosphite, trioleyl phosphite, and tris(2-ethylhexyl) phosphite, diphosphites and their higher molecular homologs, polyphosphites, partially esterified phosphonic acid compounds, tautomer form monostearyl phosphonate, distearyl phosphite and their alkali, alkaline earth salts, aluminum, or zinc salts, and phosphonites.

31. The additive composition in accordance with claim 24, wherein the organic phosphorus compound is a phosphite selected from the group consisting of 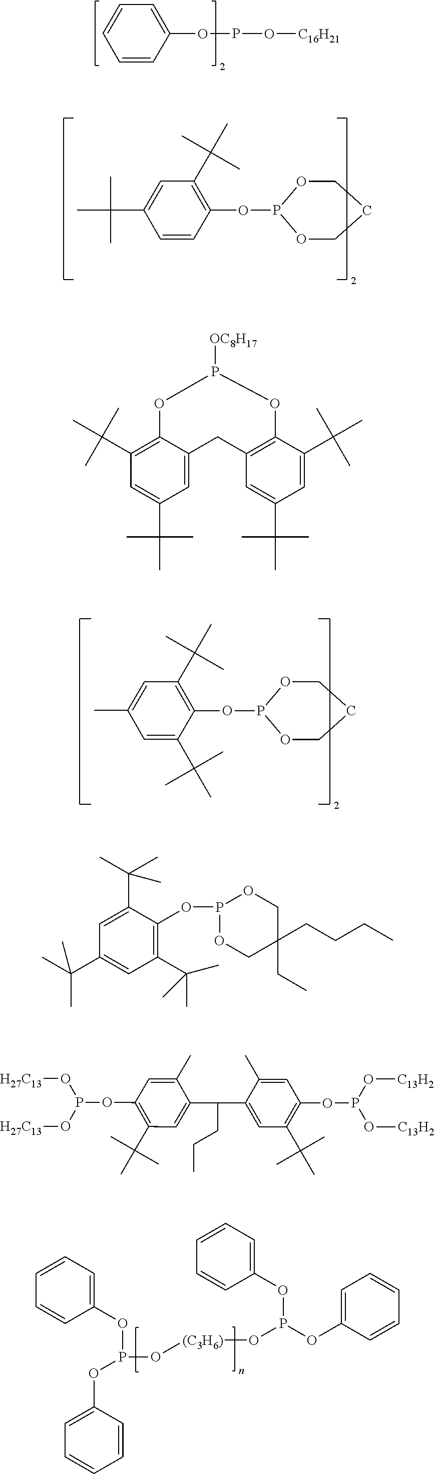 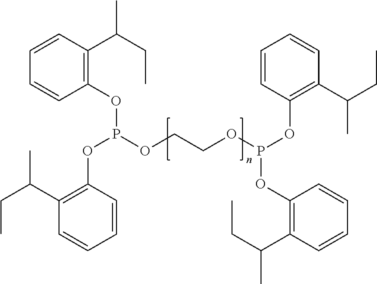
where n is from 3 to 100, 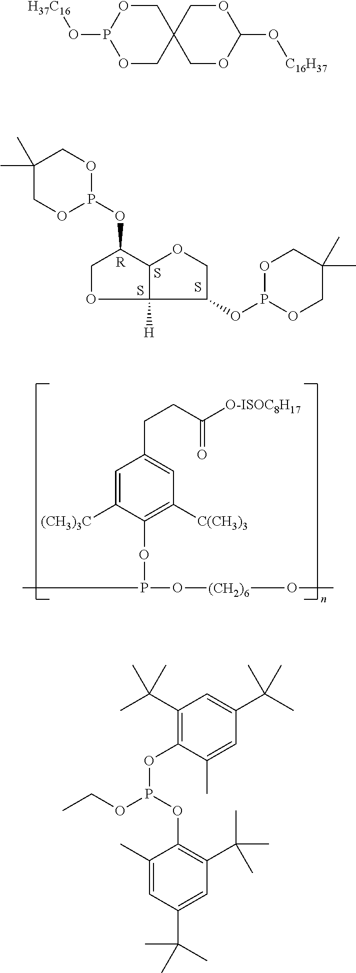
where n is from 3 to 100,

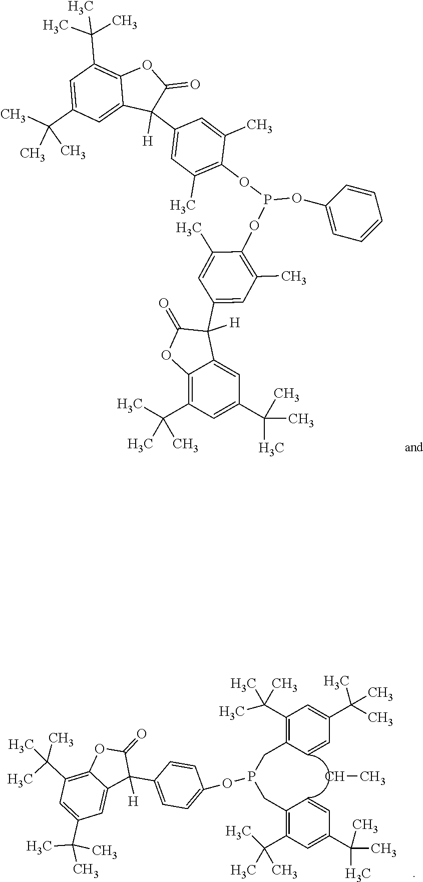

32. The additive composition in accordance with claim 24, wherein the organic phosphorus compound is a phosphonite.

33. The additive composition in accordance with claim 24, wherein the organic phosphorous compound is a phosphate.

34. The additive composition in accordance with claim 24, wherein the totality of the at least one sulfite, of the at least one organic derivative of the sulfurous acid, and/or of the at least one thiosulfate and the totality of the at least one organic phosphorus compound is present at a weight ratio of 20:1 to 1:20.

35. A condensation polymer composition comprising
(A) at least one condensation polymer, and
(B) an additive composition in accordance with claim 24.

36. The condensation polymer composition in accordance with claim 35, wherein the condensation polymer is selected from the group consisting of
polyesters of aliphatic or aromatic dicarboxylic acids and diols, polyesters of hydroxylic carbon acids, and copolymers and mixtures or blends of two or more thereof;
polyamides;
semiaromatic polyamides;
polycarbonates or polyester carbonates;
and mixtures, combinations, or blends of two or more thereof.

37. The condensation polymer composition in accordance with claim 35, wherein the condensation polymer is selected from the group consisting of PLA, PBA, and copolymers thereof.

38. The condensation polymer composition in accordance with claim 35, wherein the additive composition is present in an amount of 0.01 to 10.00 wt % with respect to the total condensation polymer composition.

39. The condensation polymer composition in accordance with claim 35, further including at least one additive selected from the group consisting of primary antioxidants, secondary antioxidants, UV absorbers, light stabilizers, metal deactivators, filler deactivators, antiozonants, nucleation agents, anti-nucleation agents, toughening agents, mold lubricants, rheological modifiers, thixotropic agents, chain extenders, processing aids, mold removal aids, flame retardant agents, pigments dyes, optical brighteners, antimicrobial active agents, antistatic agents, slip agents, anti-blocking agents, coupling agents, crosslinking agents, anti-cross-linking agents, hydrophilization agents, hydrophobing agents, hydrolysis stabilizers, bonding agents, dispersing agents, compatibilizers, oxygen scavengers, acid scavengers, expanding agents, degradation additives, defoaming agents, odor scavengers, marking agents, and anti-fogging agents.

40. The condensation polymer composition in accordance with claim 39, wherein the at least one additive is contained in the condensation polymer composition in an amount of 0.01 to 5.00 wt % with respect to the total condensation polymer composition.

41. The condensation polymer composition in accordance with claim 39, wherein up to 80 parts by weight of at least one plasticizer, filler, and/or reinforcing material is/are contained with respect to 100 parts by weight of components (A) and (B).

42. The condensation polymer composition in accordance with claim 39, wherein
(i) the degradation additives are selected from organic transition metal compounds;
(ii) the plasticizers are selected from the group consisting of tributyl acetylcitrate, tributyl citrate, triethyl acetylcitrate, triethylcitrate, glycerol triacetate, epoxidized soy bean oil, and epoxidized linseed oil;
(iii) the nucleation agents are selected from the group consisting of talcum, alkaline salts or alkaline earth salts of monofunctional and polyfunctional carboxylic acids, zinc glycerolate, 2,2′-methylene-bis-(4,6-di-tert-butylphenyl) phosphate, trisamides, and diamides;
(iv) the chain extenders are selected from the group consisting of diepoxides, bis-oxazolines, bisoxazolones, bis-oxazines, diisocyanates, dianhydrides, bis-allyllactams, bis-maleimides, dicyanates, carbodiimides, and polymer chain extenders, and
(v) the fillers and/or reinforcement materials are selected from the group consisting of calcium carbonates, silicates, talcum, mica, kaolins, metal oxides, metal hydroxides, black carbon, graphite, wood flour, fibers of natural products, fiberglass, carbon fibers, polyaramide fibers, and other synthetic polymer fibers, hydrotalcites, zeolites, and/or phyllosilicates.

43. The condensation polymer composition in accordance with claim 39, wherein the condensation polymer composition comprises:
(A) 85.00 to 99.98 parts by weight, of the at least one condensation polymer,
(B) 0.01 to 10.00 parts by weight, of the additive composition, and
(C) 0.01 to 5.00 parts by weight of the at least one additive.

44. A molding compound or a molded part made from a condensation polymer composition in accordance with claim 35.

45. A method for hydrolytically decomposing a condensation polymer comprising combining an additive composition in accordance with claim 24 to the condensation polymer and the resulting composition is exposed to a hydrolyzing condition.

46. The method of claim 44, wherein the rate of hydrolysis is higher than that of a condensation polymer not combined with the additive composition.
